(19) United States
(12) Patent Application Publication
(10) Pub. No.: US 2016/0116654 A1
(43) Pub. Date: Apr. 28, 2016

(54) LIGHT FILTER AND LENS MODULE HAVING SAME

(71) Applicant: HON HAI PRECISION INDUSTRY CO., LTD., New Taipei (TW)

(72) Inventors: SHIH-CHE CHIEN, New Taipei (TW); MING-YANG LIAO, New Taipei (TW)

(21) Appl. No.: 14/531,324

(22) Filed: Nov. 3, 2014

(30) Foreign Application Priority Data
Oct. 28, 2014 (TW) 103137295

(51) Int. Cl. G02B 5/28; G03B 11/00; G02B 7/02

(52) U.S. Cl. CPC G02B 5/285; G02B 7/02; G03B 11/00

(57) ABSTRACT

A light filter includes a base and a light filter film. The light filter film covers the base. The light filter film includes high refractive index layers and low refractive index layers stacked alternately on the base. Transmissivity of the light filter at wavelengths from about 410 nm to 640 nm and from about 830 nm to 865 nm is greater than 90%, while the average tranmissivity of the light filter at other wavelengths is less than 10%.

### FIELD

The subject matter herein generally relates to light transmission and processing.

### BACKGROUND

A light filter is capable of allowing light with a range of wavelengths to penetrate therethrough and blocking light outside the range. Therefore, the light filter is often used in an image capturing device.

### BRIEF DESCRIPTION OF THE DRAWINGS

Implementations of the present technology will now be described, by way of example only, with reference to the attached figures.

FIG. 1 is cross-sectional view of an embodiment of a light filter.

FIG. 2 is a graph showing a wavelength-transmissivity characteristic curve of the light filter of FIG. 1.

FIG. 3 is cross-sectional view of a lens module having the light filter of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented. Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a light filter comprising a base and a light filter film. The light filter film covers the base. The light filter film comprises a plurality of high refractive index layers and low refractive index layers which are alternately stacked. Transmissivity of the light filter at wavelengths from about 410 nm to 640 nm and from about 830 nm to 865 nm is greater than 90%, while the average transmissivity of the light filter at other wavelengths is less than 10%.

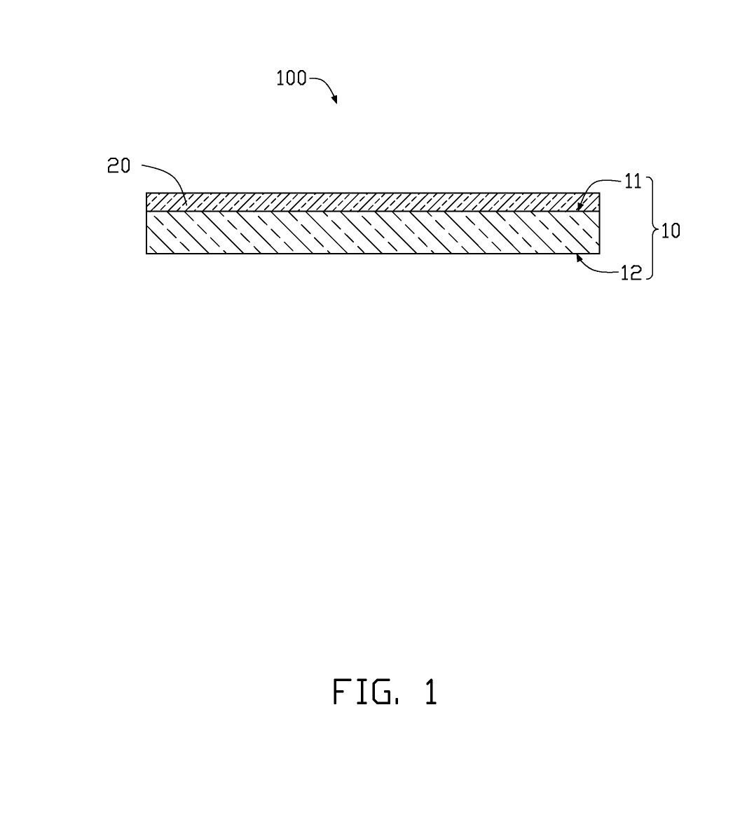

FIG. 1 illustrates a light filter 100 of an embodiment. The light filter 100 includes a base 10 and a light filter film 20. Transmissivity of the light filter 100 at wavelengths from about 410 nm to 640 nm and from about 830 nm to 865 nm is greater than 90%, while an average transmissivity of the light filter 100 at other wavelengths is less than 10%.

The base 10 is substantially a flat plate. The base 10 can be made of materials selected from a group of optical glass, sapphire, silicon, polycarbonate (PC), and polymethyl methacrylate (PMMA). In one embodiment, the base 10 is made of optical glass. A refractive index of the base 10 is in a range from about 1.46 to about 1.48. The base 10 includes a first surface 11 and a second surface 12. The first surface 11 and the second surface 12 are positioned at opposite sides of the base 10.

The light filter film 20 is arranged on the base 10. The light filter film 20 covers the first surface 11. The light filter film 20 can be formed on the first surface 11 via a sputtering method or an evaporation method. In one embodiment, the light filter film 20 is formed on the first surface 11 via an ion-assisted deposition method. The light filter film 20 includes a plurality of high refractive index layers and a plurality of low refractive index layers. The high refractive index layers and the low refractive index layers are stacked alternately on the first surface 11. The high refractive index layers have a refractive index scope ranging from about 2.15 to about 2.68. The low refractive index layers have a refractive index scope ranging from about 1.35 to about 1.48. The high refractive index layers can be made of titanium dioxide (TiO2), trititanium pentoxide (Ti3O5), tantalum oxide (Ta2O5), or niobium pentoxide (Nb2O5). The low refractive index layers can be made of aluminum oxide (Al2O3) or silicon dioxide (SiO2). In one embodiment, the high refractive layers are made of TiO2. Refractive index of the high refractive index layers is about 2.36. The low refractive layers are made of SiO2. Refractive index of the low refractive layers is about 1.46.

A total number of the high refractive index layers and low refractive index layers of the light filter film 20 is in a range from 36 to 56. In one embodiment, the total number of the high refractive index layers and the low refractive index layers of the light filter film 20 is 44. In detail, the first layer and subsequent layers, to the 44th layer in that order, are stacked on the first surface 11. An odd-number layered is a high refractive index layer and an even-numbered layer is a low refractive index layer. A film structure of the light filter film 20 satisfies the following formula: 1×(0.2H, 0.2 L, 1H, 0.1 L, 0.3H)+1×(1.5 L)+1×(1.4H, 1.5 L, 0.2H, 1.5 L, 1.7H, 0.1 L)+1×(0.6H)+2×(1.5 L, 0.4H, 1.4 L, 0.9H)+2×(1 L, 1H)+1×(2.5 L)+2×(1.1H, 1.1 L)+1×(1.3H)+6×(1.4 L, 1.4H)+1×(0.7 L), wherein H represents a high refractive index layer and L represents a low refractive index layer. The coefficient of H represents an optical thickness of the high refractive index layer and the coefficient of L represents an optical thickness of the low refractive index layer. Each variable between parentheses in the formula represents a film structure unit, and the coefficient outside the parentheses, applied to each film structure unit represents the number of the film structure unit. The materials and thicknesses of each layer of the light filter film 20 are listed in the Table 1 following. The degree of error of the optical thickness of each layer is about ±0.1, and the degree of error of the physical thickness of each layer is about ±1 nm.

TABLE 1

| Layers-order | Material | Optical thickness | Physical thickness (nm) |
|---|---|---|---|
| 1 | TiO2 | 0.218 | 17.515 |
| 2 | SiO2 | 0.224 | 28.278 |
| 3 | TiO2 | 1.085 | 87.169 |
| 4 | SiO2 | 0.104 | 13.161 |
| 5 | TiO2 | 0.345 | 27.726 |
| 6 | SiO2 | 1.533 | 193.263 |
| 7 | TiO2 | 1.400 | 112.485 |
| 8 | SiO2 | 1.596 | 201.209 |
| 9 | TiO2 | 0.239 | 19.191 |
| 10 | SiO2 | 1.566 | 197.424 |
| 11 | TiO2 | 1.756 | 141.086 |
| 12 | SiO2 | 0.069 | 8.673 |
| 13 | TiO2 | 0.657 | 52.742 |
| 14 | SiO2 | 1.473 | 185.758 |
| 15 | TiO2 | 0.363 | 29.175 |
| 16 | SiO2 | 1.359 | 171.298 |
| 17 | TiO2 | 0.889 | 71.403 |
| 18 | SiO2 | 1.330 | 167.709 |
| 19 | TiO2 | 0.370 | 29.729 |
| 20 | SiO2 | 1.287 | 162.324 |
| 21 | TiO2 | 0.904 | 72.603 |
| 22 | SiO2 | 1.093 | 137.788 |
| 23 | TiO2 | 0.946 | 75.994 |
| 24 | SiO2 | 1.067 | 134.476 |
| 25 | TiO2 | 1.066 | 85.595 |
| 26 | SiO2 | 2.499 | 315.033 |
| 27 | TiO2 | 1.111 | 89.229 |
| 28 | SiO2 | 1.111 | 140.081 |
| 29 | TiO2 | 1.079 | 86.641 |
| 30 | SiO2 | 1.229 | 155.002 |
| 31 | TiO2 | 1.289 | 103.525 |
| 32 | SiO2 | 1.433 | 180.650 |
| 33 | TiO2 | 1.390 | 111.683 |
| 34 | SiO2 | 1.451 | 182.958 |
| 35 | TiO2 | 1.372 | 110.241 |
| 36 | SiO2 | 1.392 | 175.537 |
| 37 | TiO2 | 1.289 | 103.568 |
| 38 | SiO2 | 1.362 | 171.776 |
| 39 | TiO2 | 1.346 | 108.099 |
| 40 | SiO2 | 1.441 | 181.648 |
| 41 | TiO2 | 1.382 | 111.049 |
| 42 | SiO2 | 1.438 | 181.290 |
| 43 | TiO2 | 1.387 | 111.434 |
| 44 | SiO2 | 0.724 | 91.246 |

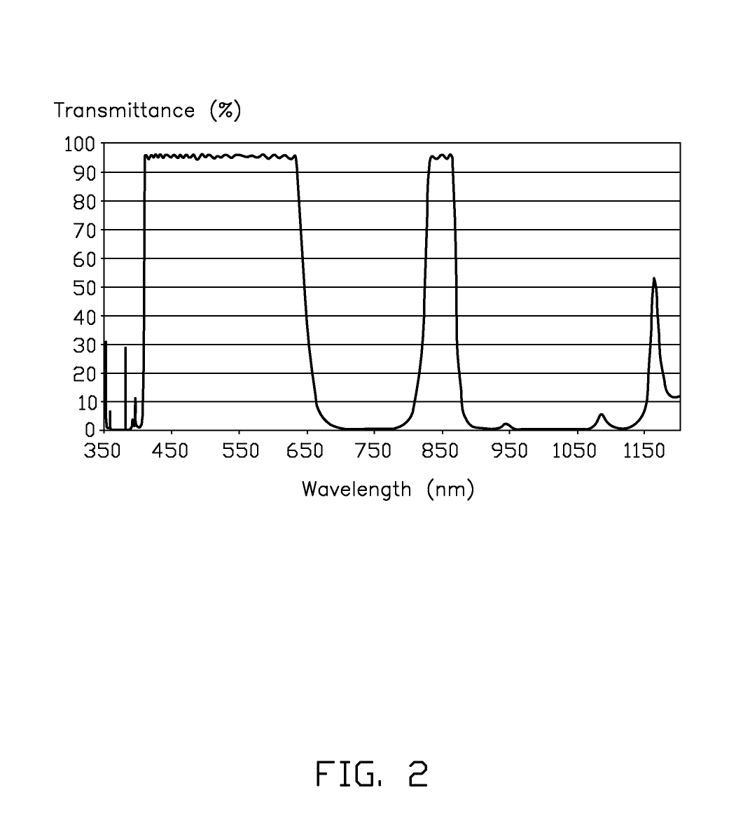

FIG. 2 illustrates that transmissivity of the light filter 100 at wavelengths from about 410 nm to 640 nm and from about 830 nm to 865 nm is greater than 90%, while average transmissivity of the light filter 100 at other wavelengths is less than 10%. Transmissivity of the light filter 100 at a wavelength of about 1160 nm is about 50%.

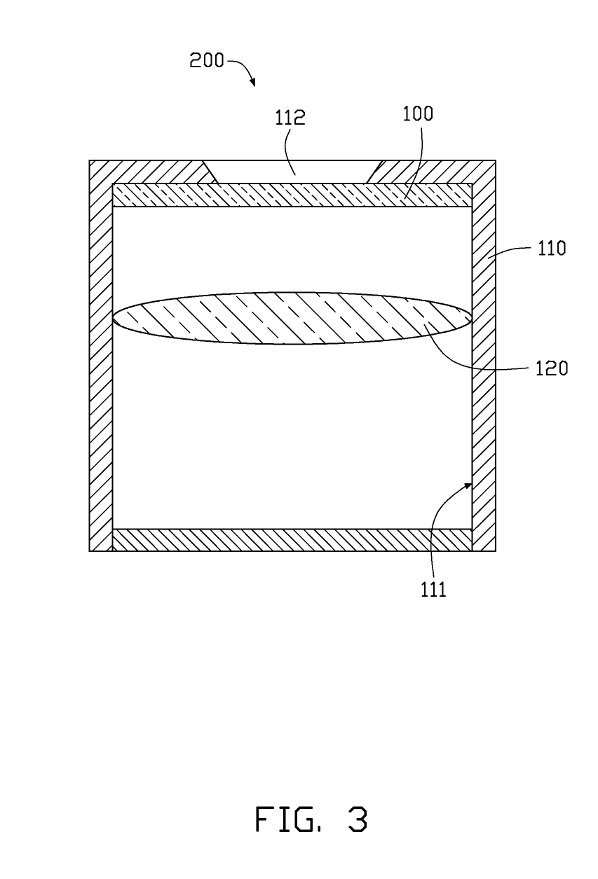

FIG. 3 illustrates a lens module 200 having the light filter 100. In one embodiment, the lens module 200 includes a light filter 100, a lens barrel 110, and a lens unit 120. The lens barrel 110 defines a cavity 111 at the image side of the lens barrel 110. The lens barrel 110 defines a through hole 112 at the object side of the lens barrel 110. The through hole 112 is coupled with the cavity 111. The through hole 112 is configured to allow light to enter the lens barrel 110. The light filter 100 and the lens unit 120 are received in the cavity 111. The light filter 100 is adjacent to the object side of the lens barrel 110. The light filter 100 faces the through hole 112. The lens unit 120 is located at a side of the light filter 100 facing away from the through hole 112. The through hole 112, the light filter 100, and the lens unit 120 are coaxial. The lens unit 120 includes at least one lens.

When in a bright environment, visible light with wavelengths ranging from 410 nm to 640 nm has a transmissivity of over 90%. In this case, the lens module 200 captures these wavelengths of visible light as images. When in a dark environment, infrared light with a wavelength ranging from 830 nm to 865 nm has a transmissivity of over 90%. In this case, the lens module 200 captures these wavelengths of infrared light as images.

The embodiments shown and described above are only examples. Many details are often found in the art such as the other features of a light filter and lens module having the light filter. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A light filter comprising:
a base;
a light filter film covering the base, comprising high refractive index layers and low refractive index layers alternately stacked on the base; and
wherein transmissivity of the light filter at wavelengths from about 410 nm to 640 nm and from about 830 nm to 865 nm is greater than 90%, while an average tranmissivity of the light filter at other wavelengths is less than 10%.

2. The light filter of claim 1, wherein transmissivity of the light filter at a wavelength of about 1160 nm is about 50%.

3. The light filter of claim 1, wherein the base is made of optical glass, sapphire, silicon, polycarbonate (PC), or polymethyl methacrylate (PMMA).

4. The light filter of claim 1, wherein the base comprises a first surface and a second surface opposite to the first surface, the light filter film covers the first surface, and one of the high refractive index layers contacts the first surface.

5. The light filter of claim 1, wherein a total number of the high refractive index layers and low refractive index layers of the light filter film is in a range from 36 to 56.

6. The light filter of claim 1, wherein the high refractive layers have a refractive index scope ranging from about 2.15 to about 2.68, the low refractive layers have a refractive index ranging from about 1.35 to about 1.48.

7. The light filter of claim 6, wherein the high refractive layers are made of titanium dioxide (TiO2), trititanium pentoxide (Ti3O5), tantalum oxide (Ta2O5), or niobium pentoxide (Nb2O5), and the low refractive layers are made of aluminum oxide (Al2O3) or silicon dioxide (SiO2).

8. The light filter of claim 1, wherein the structure of the film satisfies the following formula: 1×(0.2H, 0.2 L, 1H, 0.1 L, 0.3H)+1×(1.5 L)+1×(1.4H, 1.5 L, 0.2H, 1.5 L, 1.7H, 0.1 L)+1×(0.6H)+2×(1.5 L, 0.4H, 1.4 L, 0.9H)+2×(1 L, 1H)+1×(2.5 L)+2×(1.1H, 1.1 L)+1×(1.3H)+6×(1.4 L, 1.4H)+1×(0.7 L), wherein H represents a high refractive index layer, L represents a low refractive index layer, the coefficient of H represents an optical thickness of the high refractive index layer, the coefficient of L represent an optical thickness of the low refractive index layer, each variable between parentheses in the formula represents a film structure unit, and the coefficient of the parentheses, applied to each film structure unit represents the number of the film structure unit.

9. The light filter of claim 1, wherein materials and thicknesses of each layer of the film satisfy the following table:

| Layers-order | Material | Optical thickness | Physics thickness (nm) |
|---|---|---|---|
| 1 | TiO2 | 0.218(±0.1) | 17.515(±1) |
| 2 | SiO2 | 0.224(±0.1) | 28.278(±1) |
| 3 | TiO2 | 1.085(±0.1) | 87.169(±1) |
| 4 | SiO2 | 0.104(±0.1) | 13.161(±1) |
| 5 | TiO2 | 0.345(±0.1) | 27.726(±1) |
| 6 | SiO2 | 1.533(±0.1) | 193.263(±1) |
| 7 | TiO2 | 1.400(±0.1) | 112.485(±1) |
| 8 | SiO2 | 1.596(±0.1) | 201.209(±1) |
| 9 | TiO2 | 0.239(±0.1) | 19.191(±1) |
| 10 | SiO2 | 1.566(±0.1) | 197.424(±1) |
| 11 | TiO2 | 1.756(±0.1) | 141.086(±1) |
| 12 | SiO2 | 0.069(±0.1) | 8.673(±1) |
| 13 | TiO2 | 0.657(±0.1) | 52.742(±1) |
| 14 | SiO2 | 1.473(±0.1) | 185.758(±1) |
| 15 | TiO2 | 0.363(±0.1) | 29.175(±1) |
| 16 | SiO2 | 1.359(±0.1) | 171.298(±1) |
| 17 | TiO2 | 0.889(±0.1) | 71.403(±1) |
| 18 | SiO2 | 1.330(±0.1) | 167.709(±1) |
| 19 | TiO2 | 0.370(±0.1) | 29.729(±1) |
| 20 | SiO2 | 1.287(±0.1) | 162.324(±1) |
| 21 | TiO2 | 0.904(±0.1) | 72.603(±1) |
| 22 | SiO2 | 1.093(±0.1) | 137.788(±1) |
| 23 | TiO2 | 0.946(±0.1) | 75.994(±1) |
| 24 | SiO2 | 1.067(±0.1) | 134.476(±1) |
| 25 | TiO2 | 1.066(±0.1) | 85.595(±1) |
| 26 | SiO2 | 2.499(±0.1) | 315.033(±1) |
| 27 | TiO2 | 1.111(±0.1) | 89.229(±1) |
| 28 | SiO2 | 1.111(±0.1) | 140.081(±1) |
| 29 | TiO2 | 1.079(±0.1) | 86.641(±1) |
| 30 | SiO2 | 1.229(±0.1) | 155.002(±1) |
| 31 | TiO2 | 1.289(±0.1) | 103.525(±1) |
| 32 | SiO2 | 1.433(±0.1) | 180.650(±1) |
| 33 | TiO2 | 1.390(±0.1) | 111.683(±1) |
| 34 | SiO2 | 1.451(±0.1) | 182.958(±1) |
| 35 | TiO2 | 1.372(±0.1) | 110.241(±1) |
| 36 | SiO2 | 1.392(±0.1) | 175.537(±1) |
| 37 | TiO2 | 1.289(±0.1) | 103.568(±1) |
| 38 | SiO2 | 1.362(±0.1) | 171.776(±1) |
| 39 | TiO2 | 1.346(±0.1) | 108.099(±1) |
| 40 | SiO2 | 1.441(±0.1) | 181.648(±1) |
| 41 | TiO2 | 1.382(±0.1) | 111.049(±1) |
| 42 | SiO2 | 1.438(±0.1) | 181.290(±1) |
| 43 | TiO2 | 1.387(±0.1) | 111.434(±1) |
| 44 | SiO2 | 0.724(±0.1) | 91.246(±1) |

10. A lens module comprising:
a lens barrel defining a cavity and a through hole coupled with the cavity, the through hole being at the object side of the lens barrel; and
a light filter and a lens unit received in the cavity, the light filter facing the through hole, the light filter comprising a base and a light filter film covering the base, the light filter film comprising high refractive index layers and low refractive index layers alternately stacked on the base, wherein transmissivity of the light filter at wavelengths from about 410 nm to 640 nm and from about 830 nm to 865 nm is greater than 90%, while an average tranmissivity of the light filter at other wavelengths is less than 10%.

11. The lens module of claim 10, wherein transmissivity of the light filter at a wavelength of about 1160 nm is about 50%.

12. The lens module of claim 10, wherein the base is made of optical glass, sapphire, silicon, polycarbonate (PC), or polymethyl methacrylate (PMMA).

13. The lens module of claim 10, wherein the base comprises a first surface and a second surface opposite to the first surface, the light filter film covers the first surface, and one of the high refractive index layers contacts the first surface.

14. The lens module of claim 10, wherein a total number of the high refractive index layers and low refractive index layers of the light filter film is in a range from 36 to 56.

15. The lens module of claim 10, wherein a refractive index of the high refractive layers is in a range from about 2.15 to about 2.68, a refractive index of the low refractive layers is in a range from about 1.35 to about 1.48.

16. The lens module of claim 15, wherein the high refractive layers are made of titanium dioxide (TiO2), trititanium pentoxide (Ti3O5), tantalum oxide (Ta2O5), or niobium pentoxide (Nb2O5), and the low refractive layers are made of aluminum oxide (Al2O3) or silicon dioxide (SiO2).

17. The lens module of claim 10, wherein the structure of the film satisfies the following sormula: 1×(0.2H, 0.2 L, 1H, 0.1 L, 0.3H)+1×(1.5 L)+1×(1.4H, 1.5 L, 0.2H, 1.5 L, 1.7H, 0.1 L)+1×(0.6H)+2×(1.5 L, 0.4H, 1.4 L, 0.9H)+2×(1 L, 1H)+1×(2.5 L)+2×(1.1H, 1.1 L)+1×(1.3H)+6×(1.4 L, 1.4H)+1×(0.7 L), wherein H represents a high refractive index layer, L represents a low refractive index layer, the coefficient of H represents an optical thickness of the high refractive index layer, the coefficient of L represent an optical thickness of the low refractive index layer, each unit between parentheses represents a film structure unit, and the coefficient of the parentheses, applied to each film structure unit represents the number of the film structure unit.

18. The lens module of claim 10, wherein materials and thicknesses of each layer of the film satisfy the following table:

| Layers-order | Material | Optical thickness | Physics thickness (nm) |
|---|---|---|---|
| 1 | TiO2 | 0.218(±0.1) | 17.515(±1) |
| 2 | SiO2 | 0.224(±0.1) | 28.278(±1) |
| 3 | TiO2 | 1.085(±0.1) | 87.169(±1) |
| 4 | SiO2 | 0.104(±0.1) | 13.161(±1) |
| 5 | TiO2 | 0.345(±0.1) | 27.726(±1) |
| 6 | SiO2 | 1.533(±0.1) | 193.263(±1) |
| 7 | TiO2 | 1.400(±0.1) | 112.485(±1) |
| 8 | SiO2 | 1.596(±0.1) | 201.209(±1) |
| 9 | TiO2 | 0.239(±0.1) | 19.191(±1) |
| 10 | SiO2 | 1.566(±0.1) | 197.424(±1) |
| 11 | TiO2 | 1.756(±0.1) | 141.086(±1) |
| 12 | SiO2 | 0.069(±0.1) | 8.673(±1) |
| 13 | TiO2 | 0.657(±0.1) | 52.742(±1) |
| 14 | SiO2 | 1.473(±0.1) | 185.758(±1) |
| 15 | TiO2 | 0.363(±0.1) | 29.175(±1) |
| 16 | SiO2 | 1.359(±0.1) | 171.298(±1) |
| 17 | TiO2 | 0.889(±0.1) | 71.403(±1) |
| 18 | SiO2 | 1.330(±0.1) | 167.709(±1) |
| 19 | TiO2 | 0.370(±0.1) | 29.729(±1) |
| 20 | SiO2 | 1.287(±0.1) | 162.324(±1) |
| 21 | TiO2 | 0.904(±0.1) | 72.603(±1) |
| 22 | SiO2 | 1.093(±0.1) | 137.788(±1) |
| 23 | TiO2 | 0.946(±0.1) | 75.994(±1) |
| 24 | SiO2 | 1.067(±0.1) | 134.476(±1) |
| 25 | TiO2 | 1.066(±0.1) | 85.595(±1) |
| 26 | SiO2 | 2.499(±0.1) | 315.033(±1) |
| 27 | TiO2 | 1.111(±0.1) | 89.229(±1) |
| 28 | SiO2 | 1.111(±0.1) | 140.081(±1) |
| 29 | TiO2 | 1.079(±0.1) | 86.641(±1) |
| 30 | SiO2 | 1.229(±0.1) | 155.002(±1) |
| 31 | TiO2 | 1.289(±0.1) | 103.525(±1) |
| 32 | SiO2 | 1.433(±0.1) | 180.650(±1) |
| 33 | TiO2 | 1.390(±0.1) | 111.683(±1) |
| 34 | SiO2 | 1.451(±0.1) | 182.958(±1) |
| 35 | TiO2 | 1.372(±0.1) | 110.241(±1) |
| 36 | SiO2 | 1.392(±0.1) | 175.537(±1) |
| 37 | TiO2 | 1.289(±0.1) | 103.568(±1) |
| 38 | SiO2 | 1.362(±0.1) | 171.776(±1) |
| 39 | TiO2 | 1.346(±0.1) | 108.099(±1) |
| 40 | SiO2 | 1.441(±0.1) | 181.648(±1) |
| 41 | TiO2 | 1.382(±0.1) | 111.049(±1) |
| 42 | SiO2 | 1.438(±0.1) | 181.290(±1) |
| 43 | TiO2 | 1.387(±0.1) | 111.434(±1) |
| 44 | SiO2 | 0.724(±0.1) | 91.246(±1) |
